(19) United States
(12) Patent Application Publication
(10) Pub. No.: US 2022/0113211 A1
(43) Pub. Date: Apr. 14, 2022

(54) LEAK TESTER AND METHOD OF USE ON REFRIGERANT CIRCUIT

(71) Applicant: Robert Bosch GmbH, Stuttgart (DE)

(72) Inventor: Timothy Dooley, Machesney Park, IL (US)

(21) Appl. No.: 17/067,363

(22) Filed: Oct. 9, 2020

(51) Int. Cl. G01M 3/04; B60H 1/00

(52) U.S. Cl. CPC G01M 3/04; B60H 1/00585

(57) ABSTRACT

A leak tester for smoke testing an air conditioning refrigerant circuit. The leak tester includes an oil reservoir for containing a supply of oil. A vaporizer unit of the leak tester includes an input side coupled to the oil reservoir to receive oil from the supply of oil. A smoke output of the leak tester is coupled to an output side of the vaporizer unit. A service coupler is provided at an outlet end of the smoke output, the service coupler adapted to make a sealed connection with a low-pressure service port of the refrigerant circuit. A regulator of the leak tester is operable to set the delivery pressure of the smoke from the smoke output, and the regulator is configured to set the delivery pressure to at least 50 psi.

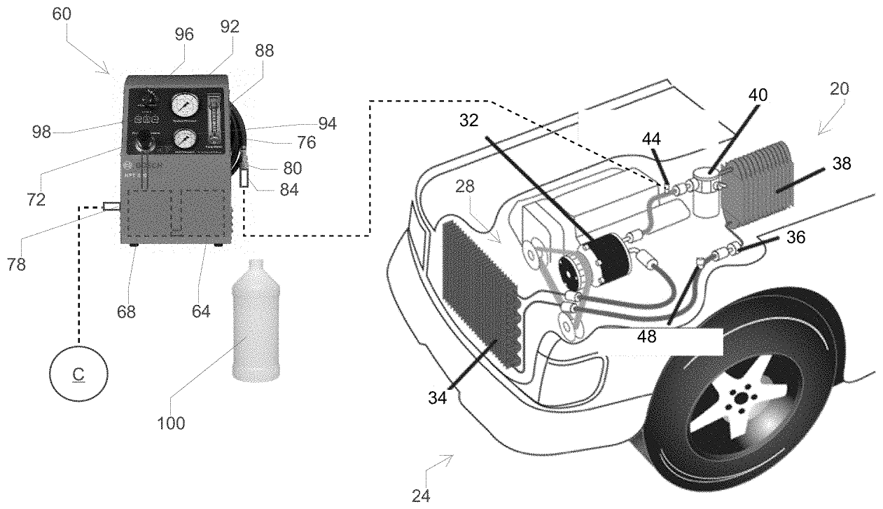

### BACKGROUND

The invention relates to diagnostic tools for closed systems, such as an air conditioning system. More particularly, the invention relates to an apparatus and method for utilizing smoke in locating a leak.

Smoke-producing leak testers and methods are widely available and known, including for example, the Bosch HPT 500 High Pressure Leak Tester that is able to produce a 20 psi supply of mineral oil vapor, or “smoke.” In the leak tester market, the Bosch HPT 500 is a high-pressure device and is useful for automotive intake and exhaust systems, including the intake side of large turbocharged car and truck engines, including diesel engines. However, there remains a need in the art for a different type of system and method that can improve leak detection performance in other fields of art, such as automotive air conditioning systems that include a closed-loop refrigerant circuit through a compressor, a condenser, an expansion valve (or orifice tube), an evaporator, a receiver/drier (or accumulator), with numerous connection points and ports or taps on both the low and high pressure sides of the circuit. Such systems can, over time, develop very small (e.g., “pin hole”) leaks that may commonly take days or weeks to locate and repair through conventional practices, such as placing dye into the circuit with the refrigerant and putting the vehicle back into normal service for a period of time before scheduling a repeat service visit for inspection. Such practices also run the test with the circuit full of refrigerant, which is presently very costly, and any leaked refrigerant is lost to atmosphere.

### SUMMARY

In one aspect, the invention provides a leak tester for smoke testing an air conditioning refrigerant circuit. The leak tester includes an oil reservoir for containing a supply of oil. A vaporizer unit of the leak tester includes an input side coupled to the oil reservoir to receive oil from the supply of oil. A smoke output of the leak tester is coupled to an output side of the vaporizer unit. A service coupler is provided at an outlet end of the smoke output, the service coupler adapted to make a sealed connection with a low-pressure service port of the refrigerant circuit. A regulator of the leak tester is provided for setting the delivery pressure of the smoke from the smoke output, and the regulator is configured to set the delivery pressure to at least 50 psi.

In another aspect, the invention provides a method of leak testing an air conditioning refrigerant circuit. A leak tester is provided, the leak tester operable to produce smoke from a supply of oil in an oil reservoir of the leak tester to be output from a smoke output of the leak tester. The oil reservoir is filled with a quantity of polyalkylene glycol (PAG) oil. The smoke output of the leak tester is connected to a low-pressure service port of the refrigerant circuit. The PAG oil in the leak tester is vaporized to produce PAG oil smoke, and the PAG oil smoke is provided from the smoke output at a pressure of at least 50 psi to the low-pressure service port. A visual inspection of the refrigerant circuit is performed for the presence of leaking smoke.

### BRIEF DESCRIPTION OF THE DRAWING

The drawing is a schematic view of a mobile refrigerant system and a leak tester for use with the mobile refrigerant system.

### DETAILED DESCRIPTION

The drawing illustrates a mobile refrigerant system, or “air conditioning system” 20 provided in a passenger vehicle 24. For example, the air conditioning system 20 is provided partially or fully in an engine compartment 28 of the vehicle 24. The air conditioning system 20 provides, among other things, communication with a vehicular HVAC system for blowing cooled air into the passenger compartment of the vehicle 24. As is known in the art, the air conditioning system 20 is provided by a closed-loop refrigerant circuit including a compressor 32, a condenser 34, an expansion valve (or orifice tube) 36, an evaporator 38, a receiver/drier (or accumulator) 40. The air conditioning system 20 further includes a first service port 44 at the low-pressure side of the refrigerant circuit and a second service port 48 at the high-pressure side of the refrigerant circuit. The service ports 44, 48 can be SAE compliant (J2197 and/or J2888) for R134a or R1234yf. As can also be appreciated from the drawing, the compressor 32 can be driven from a prime mover (e.g., internal combustion engine) that propels the vehicle 24. Alternately, the compressor 32 can be separately driven, for example by a small electric motor. Although the drawing illustrates one exemplary construction for a conventional passenger car, the air conditioning system 20 can be provided in numerous types of passenger or industrial/construction/agricultural vehicles powered by conventional gasoline or diesel engines, hybrid electric power trains, or even fully electric vehicles. On the high-pressure side of the air conditioning system 20, refrigerant is commonly pressurized to over 100 psi, for example up to 350 psi or 400 psi, depending upon the system configuration and the particular cooling demands at a given time. Polyalkylene glycol (PAG) oil is mixed in with the refrigerant (e.g., R134a or R1234yf) for enhancing lubricating properties, particularly for lubricating the compressor 32, which contains internal moving parts operable to pressurize the refrigerant. PAG oil, also commonly referred to as polyglycol oil, is a fully synthetic hygroscopic oil made for automotive compressor components.

To the left of the vehicle 24, the drawing further illustrates a leak tester 60 according to one embodiment of the present disclosure. As will be appreciated from the following description, the leak tester 60 is adapted for smoke testing a refrigerant circuit such as that of the air conditioning system 20. The leak tester 60 includes an oil reservoir 64 for containing a supply of oil. The oil reservoir 64 can be refillable to service or recharge the leak tester 60, as the oil is a consumable to be output from the leak tester 60. The oil reservoir 64 is coupled to a vaporizer unit 68 operable to vaporize the liquid oil from the oil reservoir 64 into visible oil vapor particles, or “smoke.” In particular, the vaporizer unit 68 has an input side coupled to the oil reservoir 64, while an output side of the vaporizer unit 68 is coupled, through a pressure regulator 72, to a smoke output which is shown herein as a hose 76. The vaporizer unit 68 can include a pump (e.g., electric pump) coupled to deliver pumped fluid to a heat exchanger of the vaporizer unit 68. The regulator 72 is operable to set the delivery pressure of the smoke from the smoke output hose 76. Contrary to conventional leak testers, the regulator 72 is configured to adjust and set the smoke delivery pressure to at least 50 psi (e.g., at least 60 psi, at least 70 psi, at least 80 psi, or at least 100 psi). Compressed air, or “shop air,” from a separate supply of compressed air such as a nearby air compressor C is provided to an air inlet port 78 of the leak tester 60. The smoke output hose 76 can be constructed of a flexible material (e.g., rubber) and may optionally be coiled and stored on an exterior body or case of the leak tester 60. The smoke output hose 76 provides an outlet end 80 having an opening to emit the smoke for use outside the leak tester 60. The outlet end 80 of the smoke output hose 76 can be provided as a service coupler adapted to make a sealed connection with the low pressure service port 44 of the refrigerant circuit. Alternately, such a service coupler can be provided as a separate adapter 84 that is coupled to a fitting at the outlet end 80 of the hose 76. For example, the hose 76 can have a standardized fitting (e.g., threaded or barbed fitting, or ¼ inch female NPT air coupler fitting) at the outlet end 80 thereof that is incompatible for direct connection with the low-pressure service port 44. An exemplary adapter 84 is Part No. 18190A from Robinair, a Bosch Automotive Service Solutions brand, located in Owatonna, Minn. As mentioned above, the low-pressure service port 44 can conform to automotive industry standard(s) and may be provided as a quick-disconnect fitting. The low-pressure service port 44 can house an internal valve (e.g., Schrader valve), and the service coupler (on the outlet end 80 of the hose 76 or of the adapter 84 coupled thereto) includes a structure for actuating the valve to an open position.

In addition to the features described above, the leak tester 60 can include any or all of: a flow meter 88, a system pressure gauge 92, a test pressure gauge 94, a flow control adjuster 96, and a bank of selector switches 98. Any or all of these displays and/or controls can be positioned on a front control panel of the leak tester 60. The layout and operation may be similar to other conventional leak testers, such as the currently available Bosch HPT 500, for example. Other layouts and features are optional. The flow control adjuster 96 is operable to adjust and set the flow rate of the smoke output, and the flow meter 88 is operable to display the flow rate of the smoke output. The selector switches 98 can include respective switches for Vapor Test, Air Only Test, and Reset. It is also noted that the leak tester 60 can be provided, for example packaged and sold, as a kit including a bottle 100 of PAG oil.

The leak tester 60 can be used to perform a method of leak testing a refrigerant circuit such as that of the air conditioning system 20. The leak testing can be performed in response to a user noting poor performance or lack of performance of the air conditioning system 20 during operation of the vehicle 24. The leak tester 60 is provided at the vehicle service site, for example in an automotive workshop service bay where the vehicle 24 has been stationed. The air conditioning system 20 is evacuated of existing refrigerant. The oil reservoir 64 of the leak tester 60 is filled with a quantity of PAG oil (e.g., from the bottle 100). Optionally, fluorescent dye may be added to the oil reservoir 64. The smoke output hose 76 of the leak tester 60 is connected to the low-pressure service port 44 of the refrigerant circuit. This connection is made either with the separate adapter 84, or without any adapter if the smoke output hose 76 is formed, at its outlet end 80, to include the service coupler for connection with the low-pressure service port 44. Shop air, at a pressure at least as high as the desired test pressure, is connected to the air inlet port 78 of the leak tester 60. The leak tester 60 is turned on and put into an operational mode such that the vaporizer unit 68 operates to vaporize the PAG oil in the leak tester 60 to produce PAG oil smoke. The regulator 72 is set (e.g., adjusted if necessary) to a delivery pressure of at least 50 psi (e.g., at least 60 psi, at least 70 psi, at least 80 psi, or at least 100 psi). The PAG oil smoke is provided from the smoke output hose 76 at the regulated pressure into the refrigeration circuit through the low-pressure service port 44. The vehicle 24, including the air conditioning system 20, remains off during the test. Once the smoke flows from the leak tester 60 into the refrigeration circuit to fill the refrigeration circuit, visual inspection of the refrigerant circuit is conducted for the presence of leaking smoke. The observation of smoke emanating from a component, fitting, or hose of the air conditioning system 20 indicates a failure point that requires repair or replacement to reseal the refrigerant circuit from the atmosphere and restore the performance of the air conditioning system 20. The flow meter 88 can also be observed to see if the flow rate settles to zero, indicative of the absence of leaks. If fluorescent dye is added to the reservoir 64, inspection may include inspection with the aid of a black light (e.g., blue, violet, or ultraviolet flashlight) to highlight the glowing dye. Optionally, a follow-up leak test on the refrigerant circuit can be conducted, according to the same procedure, following a repair to confirm efficacy of the repair. The receiver/drier (or accumulator) 40 can be replaced as part of the test/repair procedure. This ensures that any moisture introduced during testing does not adversely affect future performance of the air conditioning system 20.

The leak tester 60 and corresponding method disclosed herein are particularly beneficial in identifying small “pinhole” leaks that are otherwise extremely difficult and/or time consuming to locate. Even if a conventional smoke machine or leak tester was utilized on such a leak, the relatively low pressures achieved by such machines are insufficient to demonstrate the leak by passage of smoke. Such smoke machines are not advised for use on refrigeration circuits and can only practically be used to find gross or macro-level leaks. Thus, conventionally, smoke machines can find only very limited use for refrigerant circuits like those of the air conditioning system 20. Furthermore, it is inadvisable to introduce foreign substances into a refrigerant circuit (i.e., mineral oil from a conventional smoke machine acts as a contaminant)—a problem that is avoided according to the present disclosure by the use of PAG oil as the smoke source in the leak tester 60.

Various features of the present disclosure are set forth in the following claims.

What is claimed is:

1. A leak tester for smoke testing an air conditioning refrigerant circuit, the leak tester comprising:
an oil reservoir for containing a supply of oil;
a vaporizer unit having an input side coupled to the oil reservoir to receive oil from the supply of oil;
a smoke output coupled to an output side of the vaporizer unit;
a service coupler provided at an outlet end of the smoke output, the service coupler adapted to make a sealed connection with a low-pressure service port of the refrigerant circuit; and
a regulator operable to set the delivery pressure of the smoke from the smoke output, wherein the regulator is configured to set the delivery pressure to at least 50 psi.

2. The leak tester of claim 1, wherein the regulator is configured to set the delivery pressure to at least 60 psi.

3. The leak tester of claim 2, wherein the regulator is configured to set the delivery pressure to at least 70 psi.

4. The leak tester of claim 3, wherein the regulator is configured to set the delivery pressure to at least 80 psi.

5. The leak tester of claim 4, wherein the regulator is configured to set the delivery pressure to at least 100 psi.

6. The leak tester of claim 1, wherein the smoke output includes a hose, and wherein the service coupler is provided directly at the outlet end of the hose.

7. The leak tester of claim 1, wherein the smoke output includes a hose, and wherein the service coupler is provided as an adapter coupled to a fitting at the outlet end of the hose.

8. The leak tester of claim 1, wherein the service coupler conforms to an automotive industry standard and is adapted to actuate a Schrader valve within the low-pressure service port.

9. The leak tester of claim 1, wherein the smoke output includes a flexible hose.

10. The leak tester of claim 1, wherein the oil reservoir contains a supply of polyalkylene glycol (PAG) oil.

11. The leak tester of claim 1, further comprising a control panel including a flow control adjuster operable to set the flow rate of the smoke.

12. The leak tester of claim 11, wherein the control panel includes a flow meter operable to display a flow rate of the smoke.

13. A leak tester kit for smoke testing an air conditioning refrigerant circuit, the leak tester kit comprising:
the leak tester of claim 1; and
a bottle of polyalkylene glycol (PAG) oil.

14. A method of leak testing an air conditioning refrigerant circuit, the method comprising:
providing a leak tester operable to produce smoke from a supply of oil in an oil reservoir of the leak tester to be output from a smoke output of the leak tester;
filling the oil reservoir with a quantity of polyalkylene glycol (PAG) oil;
connecting the smoke output of the leak tester to a low-pressure service port of the refrigerant circuit;
vaporizing the PAG oil in the leak tester to produce PAG oil smoke;
providing the PAG oil smoke from the smoke output at a pressure of at least 50 psi to the low-pressure service port; and
performing a visual inspection of the refrigerant circuit for the presence of leaking smoke.

15. The method of claim 14, wherein the PAG oil smoke is provided from the smoke output to the low-pressure service port at a pressure of at least 60 psi.

16. The method of claim 14, wherein the PAG oil smoke is provided from the smoke output to the low-pressure service port at a pressure of at least 70 psi.

17. The method of claim 14, wherein the PAG oil smoke is provided from the smoke output to the low-pressure service port at a pressure of at least 80 psi.

18. The method of claim 14, wherein the PAG oil smoke is provided from the smoke output to the low-pressure service port at a pressure of at least 100 psi.

19. The method of claim 14, wherein the smoke output of the leak tester is connected to the low-pressure service port of the refrigerant circuit with an adapter.

20. The method of claim 14, further comprising adding fluorescent dye to the PAG oil in the oil reservoir.
